(19) United States
(12) Patent Application Publication
(10) Pub. No.: US 2008/0246771 A1
(43) Pub. Date: Oct. 9, 2008

(54) GRAPHICS PROCESSING SYSTEM AND METHOD

(75) Inventors: Sean Patrick O'Neal, Austin, TX (US); Lawrence Edward Knepper, Lago Vista, TX (US); Reynold L. Liao, Austin, TX (US)

Correspondence Address: HAYNES AND BOONE, LLP, 901 Main Street, Suite 3100, Dallas, TX, 75202, US

(73) Assignee: DELL PRODUCTS L.P., Round Rock, TX (US)

(21) Appl. No.: 11/695,816

(22) Filed: Apr. 3, 2007

(51) Int. Cl. G06F 15/16

(52) U.S. Cl. 345/503

(57) ABSTRACT

A graphics processing system and method for displaying an image having first and second graphics processors coupled together. A main display device is coupled to the first graphics processor. Secondary display devices are coupled to the second graphics processor. The first and second graphics processors are operable to share processing for displaying the image on the main display, or the first graphics processor is operable to process a main portion of the image for displaying the main portion of the image on the main display and the second graphics processor is operable to process secondary portions of the image for displaying the secondary portions of the image on the secondary display devices.

### BACKGROUND

The present disclosure relates generally to information handling systems, and more particularly to graphics processing for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Some IHSs have multiple video display devices connected at the same time for displaying a desired image to each of the display devices. Traditionally, these display devices are each driven by separate graphics processing units within the IHS. Thus, the quality of the displayed image is determined by the performance of the graphics processing unit supporting the respective display device. Additionally, there are systems that connect multiple graphics processing units together to combine the performance of the multiple graphics processing units to feed a single display unit. This is desirable for enhanced video performance for applications such as video gaming.

Accordingly, it would be desirable to provide an improved graphics processing system and method.

### SUMMARY

A graphics processing system and method for displaying an image having first and second graphics processors coupled together. A main display device is coupled to the first graphics processor. Secondary display devices are coupled to the second graphics processor. The first and second graphics processors are operable to share processing for displaying the image on the main display, or the first graphics processor is operable to process a main portion of the image for displaying the main portion of the image on the main display and the second graphics processor is operable to process secondary portions of the image for displaying the secondary portions of the image on the secondary display devices.

### BRIEF DESCRIPTION OF THE DRAWINGS

FIG. 1 is a block diagram illustrating an embodiment of an IHS.

FIG. 2 is a block diagram illustrating an embodiment of an IHS including a graphics processing system.

FIG. 3 is an illustration of an embodiment of the IHS of FIG. 2.

FIG. 3A is another illustration of the embodiment of the IHS of FIG. 2.

FIG. 4 is a block diagram illustrating an embodiment of a method for transitioning between different states for the graphics processing system of FIGS. 2, 3 and 3A.

### DETAILED DESCRIPTION

For purposes of this disclosure, an IHS includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, read only memory (ROM), and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit communications between the various hardware components.

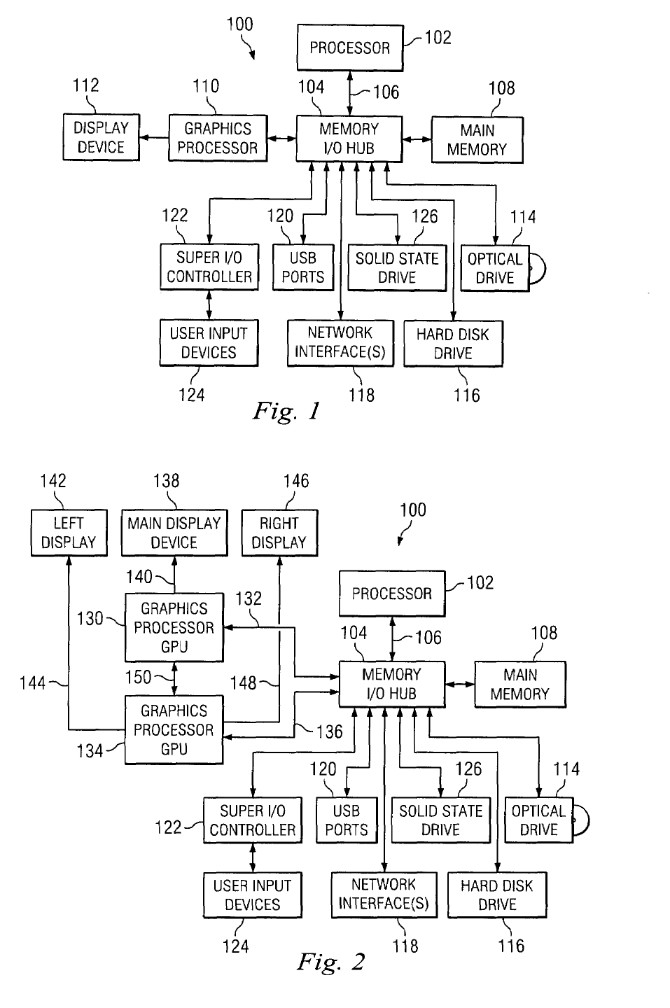

FIG. 1 is a block diagram of one IHS. The IHS 100 includes a processor 102 such as an Intel Pentium series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. It is also becoming feasible to use solid state drives (SSDs) 126 in place of, or in addition to main memory 108 and/or a hard disk drive 116.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

FIG. 2 shows a block diagram of an embodiment of an IHS 100 having graphics processing units (GPU) 130 and 134 electrically coupled to the memory I/O hub 104 using PEG links 132 and 136 respectively. GPU generally refers to a complete graphics subsystem having a graphics processing unit application specific integrated circuit, local frame buffer memory, regulators and peripheral electronics. However, more or less components may be associated with the GPUs 130, 134 of this disclosure. A connection of PEG links 132, 136 connecting the GPUs 130, 134 to the memory I/O hub 104 is generally understood by those ordinarily skilled in the art. The IHS 100 has a main display device 138 electrically connected to the GPU 130 using a video link 140. In addition, a left display device 142 and a right display device 146 are electrically connected to the GPU 134 using video links 144 and 148 respectfully. In this embodiment, the GPU 134 is configured to drive at least two independent secondary display devices such as 142 and 146. A dual Gfx link 150 electrically connects the GPU 130 with the GPU 134. In one embodiment, the graphics processing system and method dynamically allocate graphics card output and performance between multiple display devices 138, 142, 146 connected to the IHS 100.

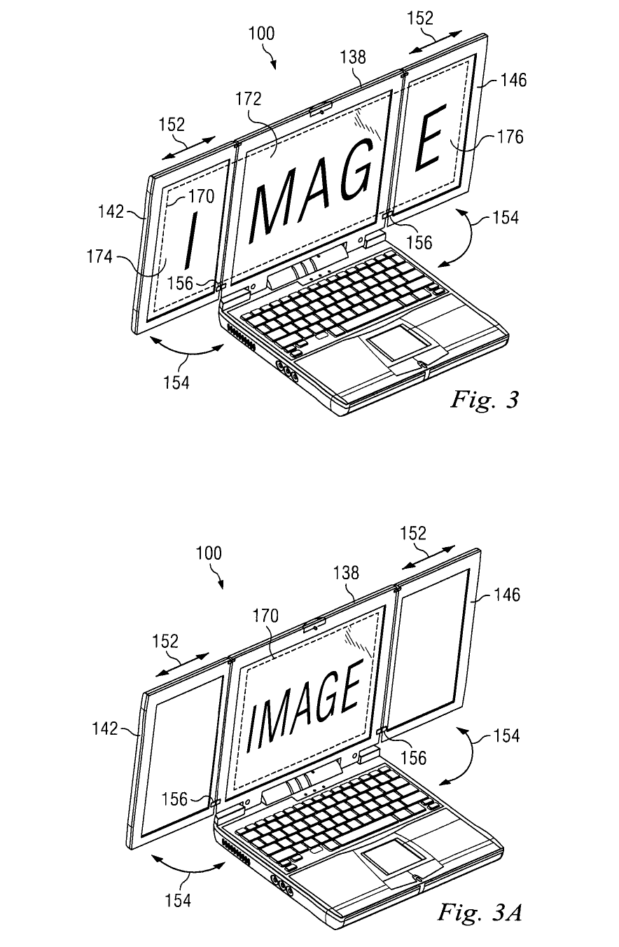

In an embodiment shown in FIG. 3, the main display device 138 is an LCD panel display for a notebook-type computer or IHS 100 and the left secondary display device 142 and the right secondary display device 144 are shown as fold-out 154 or slide-out 152 LCD panel display devices for enlarging a viewing area while using the IHS 100. However, the display devices 138, 142, 146 can be cathode ray tube (CRT) devices, plasma devices, projection devices or any other type of display devices. The left and right display devices 142, 146 are described as “left” and “right” for simplicity and can be located in any orientation with respect to the main display device 138 and also with each other. Thus, the disclosed graphics processing system and method can be used for gaming systems, home entertainment systems, theater systems, or any other suitable graphics applications where it is desirable to have multiple display devices 138, 142, 146 displaying an image 170. In addition, the graphics processing system can be sized with any number and size of display devices 138, 142, 146 and with any number of GPUs 130, 134.

After receiving image data from the processor 102 and/or the memory I/O hub 104, the GPUs 130, 134 process the data and send the data to the display devices 138, 142, 146 via the video links 140, 144, 148 respectively. The embodiment of the graphics processing system shown in FIGS. 2 and 3 can be operated in at least two modes. First, the secondary display devices 142, 146 are turned on, opened, or otherwise deployed for use. Then, the image 170 that is to be displayed is divided into three portions, a center, main portion 172, a left, secondary portion 174 and a right, secondary portion 176. The GPU 130 processes graphics for and drives the main display device 138, displaying the center portion 172 of the image 170 on the main display device 138, while the GPU 134 processes graphics for and drives the left and right display devices 142, 146 displaying the left portion 174 and the right portion 176 of the image 170 on the left display device 142 and the right display device 146 respectively. This creates a continuous view of the image 170 across all three display devices 138, 142, 146. Therefore, a larger view of the image 170 can be displayed than when only displaying the image 170 on the main or center display device 138. Second, the left and right display devices 142, 146 can be turned off, closed, or otherwise not used and the image 170 is only displayed on the main display device 138, see FIG. 3A. In this mode, GPUs 130 and 134 combine processing performance using the Gfx link 150 between the GPUs 130, 134 to process and drive the image 170 on the main display device 138. This mode provides a smaller view of the image 170, but at a higher performance level. This extra processing power can be helpful for speeding up graphics processing/frame rate in gaming, or other complex graphics applications. This mode approximately doubles the graphics processing performance of the IHS 100 when using just the main display device 138 to display the image 170.

In one embodiment, the main display device 138 is larger than the left and right display devices 142, 146. For example, the main display device 138 could have a resolution or image size of 2048×1536 (a 4:3 aspect ratio), and each of the secondary display devices 142, 146 could have a resolution of 1024×1536 (a 2:3 aspect ratio), or about half the size of the main display device 138. With this configuration, the combined area of the left and right display devices 142, 146 is about equal to the area of the main display device 138. Because GPU 130 is configured to drive the main display device 138, while the other GPU 134 is configured to drive both the left and right display devices 142, 146, this provides a balanced performance in driving the total combined image area for all of the display devices 138, 142, 146 when both GPUs 130, 134 are rated for the same performance level.

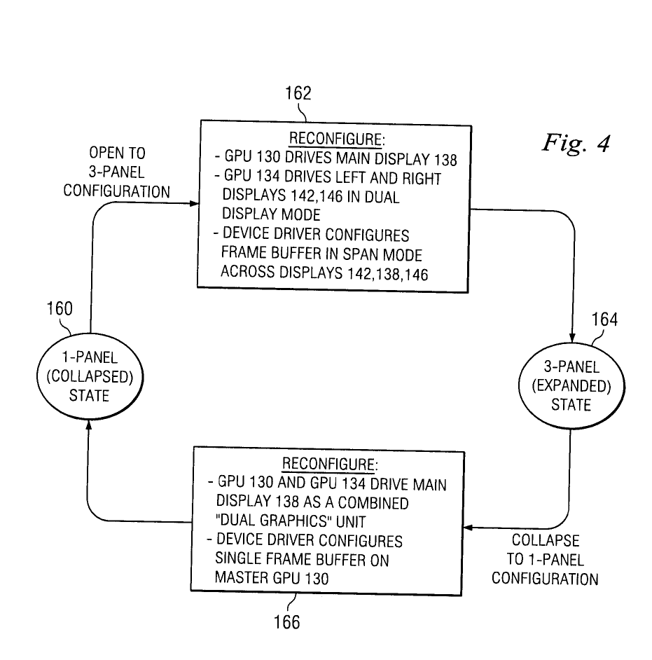

FIG. 4 shows a block diagram illustrating an embodiment of a method to transition between different states (collapsed/closed and expanded/deployed) and back for the graphics processing system of FIGS. 2 and 3. In 160, the IHS 100 has the left and right display devices 142, 146 collapsed, closed, or otherwise off and is only displaying the image 170 on the main display device 138. Once the left and right display devices 142, 146 are expanded, opened or otherwise turned on, the system reconfigures in 162 where the GPU 130 drives the main display device 138 and the GPU 134 drives the left and right display devices 142, 146 in dual display mode, thereby configuring the frame buffer in span mode across displays 138, 142, and 146. This displays the image 170 on all three display devices 138, 142 and 146 in 164 where a portion of the image is displayed on each display device 138, 142, and 146. For example, the center portion 172 of the image 170 is displayed on the main or center display device 138, the left portion 174 of the image 170 is displayed on the left secondary display device 142 and the right portion 176 of the image 170 is displayed on the right secondary display device 146. Then, to improve graphics performance, a user can collapse, close, or otherwise turn off the left and right secondary display devices 142, 146 and the system will reconfigure operation as shown in 166. To reconfigure the system In 166, the GPU 130 and GPU 134 work together via the Dual Gfx link 150 to drive the main display device 138 as a combined “dual graphics” unit where GPU 130 is a single frame buffer master device controlling GPU 134 as a slave device. Then again, the system can operate in single panel mode 160 showing the image 170 only on the main display device 138, but at a higher performance level. In each state 160, 164, the device driver performs reconfiguration and then reports the new frame buffer configuration and any other relevant information to the IHS 100 operating system.

In the single display device or collapsed state 160, the IHS 100 uses the combined processing power of both GPUs 130, 134 in a “dual graphics” mode. This provides the highest performance configuration and can be used in applications like game play or other high graphics content workstation applications where high graphics performance is required. This could use commercially available GPUs that are capable of performing in a “dual graphics” mode. In the expanded or deployed state 164, each GPU 130, 134 draws into approximately the same frame buffer space and thereby provides optimal performance balance between the image being constructed across all three display devices 138, 142, 146. Therefore, optimal performance is obtained in either collapsed 160 or expanded 164 state, depending on the user's needs.

It is possible for the GPUs 130, 134 to have a mechanism to detect whether the secondary display devices 142, 146 are deployed or opened on a notebook-type or other type of IHS 100 and to use this information to trigger configuration or mode changes as shown in FIG. 4. As an example, this can be accomplished by using a mechanical or magnetic switch 156 or other sensor device operatively connected to the display devices 142, 146 and electrically coupled to a general purpose I/O (GPIO) on the IHS 100 to inform the system and the GPUs 130, 134 whether the configuration is set for single display device operation (collapsed) or multiple display device operation (expanded). Then, as changes in the switch occur (the display devices 142, 146 are expanded/deployed or collapsed) the system can adjust operation mode to dynamically allocate video output to optimize for the main display device 138 or for all of the display devices 138, 142 and 146.

In summary, one embodiment of a graphics processing system and method for displaying an image 170 is shown in FIGS. 2-4. These figures provide an IHS 100 having first graphics processor 130 and second graphics processor 134 coupled together. A main display device 138 is coupled to the first graphics processor 130. Secondary display devices 142, 146 are coupled to the second graphics processor 134. The first and second graphics processors 130, 134 are operable to share processing for displaying the image 170 on the main display 138 only, or the first graphics processor 130 is operable to process a main portion 172 of the image 170 for displaying the main portion 172 of the image 170 on the main display 138 and the second graphics processor 134 is operable to process secondary portions 174, 176 of the image 170 for displaying the secondary portions 174, 176 of the image 170 on the secondary display devices 142, 146.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A graphics processing system for displaying an image, the system comprising:
a first graphics processor configured to couple with a main display device; and
a second graphics processor coupled to the first graphics processor and configured to couple with secondary display devices, whereby the first and second graphics processors are operable to share processing for displaying the image on the main display, and whereby the first graphics processor is operable to process a main portion of the image for displaying the main portion of the image on the main display and the second graphics processor is operable to process secondary portions of the image for displaying the secondary portions of the image on the secondary display devices.

2. The graphics processing system of claim 1 wherein a surface area of the main display device is substantially the same as a sum of surface areas of the secondary display devices.

3. The graphics processing system of claim 1 wherein at least one of the display devices is an LCD display device.

4. The graphics processing system of claim 1 wherein one of the graphics processors detects whether the secondary display devices are deployed.

5. The graphics processing system of claim 4 further comprising:
a switch to detect if the secondary display devices are deployed.

6. The graphics processing system of claim 1 wherein the first graphics processor uses substantially the same frame buffer space as the second graphics processor to provide balanced operation performance.

7. The graphics processing system of claim 1 wherein the secondary display devices expand outward from the main display device creating a larger overall display area.

8. An information handling system comprising:
a data processor;
a first graphics processor coupled to the data processor and configured to couple with a main display device; and
a second graphics processor coupled to the data processor and electrically coupled to the first graphics processor and configured to couple with secondary display devices, whereby the first and second graphics processors are operable to share processing for displaying the image on the main display, and whereby the first graphics processor is operable to process a main portion of the image for displaying the main portion of the image on the main display and the second graphics processor is operable to process secondary portions of the image for displaying the secondary portions of the image on the secondary display devices.

9. The information handling system of claim 8 wherein a surface area of the main display device is substantially the same as a sum of surface areas of the secondary display devices.

10. The information handling system of claim 8 wherein at least one of the display devices is an LCD display device.

11. The information handling system of claim 8 wherein the one of the graphics processors detects whether the secondary display devices are deployed.

12. The information handling system of claim 11 further comprising:
a switch to detect if the secondary display devices are deployed.

13. The information handling system of claim 8 wherein the first graphics processor uses substantially the same frame buffer space as the second graphics processor to provide balanced operation performance.

14. The information handling system of claim 8 wherein the secondary display devices expand outward from the main display device creating a larger overall display area.

15. A method of transitioning between displaying an image on a single display device and displaying the image on multiple display devices, the method comprising:
providing a main display device and multiple secondary display devices in proximity to the main display device, wherein the main display device is operable to be used alone or in conjunction with the multiple secondary display devices to display the image;
processing the image using a first graphics processing unit and a second graphics processing unit and displaying the image only on the main display device; and
processing a main portion of the image using the first graphics processing unit and displaying the main portion of the image on the main display device and simultaneously processing multiple portions of the image adjacent to the main portion, using the second graphics processing unit and displaying the multiple portions of the image on the multiple secondary display devices.

16. The method of claim 15 further comprising:
permitting a user to switch between using the main display device to display the image and using all of the display devices to display the image.

17. The method of claim 15 further comprising:
reporting a frame buffer configuration to an operating system.

18. The method of claim 15 further comprising:
detecting when the two secondary display devices are ready to display portions of the image.

19. The method of claim 15 wherein the image displays at an enhanced performance level when being displayed only on the main display device relative to splitting the image into multiple portions and displaying the multiple portions on the multiple display devices.

20. The method of claim 15 wherein the providing a device having a main display device and multiple secondary display devices in proximity to the main display device is performed by providing a notebook-type computer device having the display devices.
